(19) United States
(12) Patent Application Publication
(10) Pub. No.: US 2015/0130192 A1
(43) Pub. Date: May 14, 2015

(54) GRAVITY BASED ENERGY CONVERSION DEVICE

(71) Applicant: Loganathan Palani, Bangalore (IN)

(72) Inventor: Loganathan Palani, Bangalore (IN)

(21) Appl. No.: 14/401,522

(22) PCT Filed: May 17, 2013
(86) PCT No.: PCT/IN2013/000321

§ 371 Date: Nov. 16, 2014

(30) Foreign Application Priority Data
May 17, 2012 (IN) 1974/CHE/2012

(51) Int. Cl. F03B 13/06; H02K 7/18; F03B 17/00

(52) U.S. Cl. CPC F03B 13/06; F03B 17/005; H02K 7/1853; F03B 17/04
USPC 290/1 A; 415/916

(57) ABSTRACT

The present invention provides a gravity based energy conversion system. The gravity based energy conversion system includes a circular pulley, a first container, a second container, a rotational energy conversion unit, and an electric energy generation unit. The first container and the second container are suspended on either sides of the circular member using a connecting member. According to the present invention, weight of the first container and the second container is altered to obtain continuous ascending and descending movements of the first container and the second container. The ascending and descending movements of the first container and the second container generates a bi-directional circular motion at the circular member. The rotational energy conversion unit converts the bi-directional circular motion of the circular member into a unidirectional rotational movement. The rotational energy conversion unit feeds the rotational energy to the electrical energy generation unit which then generates electric energy.

### RELATED APPLICATION

Benefit is claimed to Indian Provisional Application No. 1974/CHE/2012 titled “GRAVITY BASED ENERGY CONVERSION DEVICE” by LOGANATHAN, Palani, filed on 17^{th} May 2012, which is herein incorporated in its entirety by reference for all purposes.

### FIELD OF THE INVENTION

The present invention relates generally to the field of electrical energy generation system, and more specifically to electric energy generation from gravitational energy.

### BACKGROUND OF THE INVENTION

Consumption of electrical energy has undergone a relatively rapid increase in resent years. There is a constant driving force throughout recent human history about developing novel methods for generating electrical energy. The reason being is depletion of world's supply of non-renewable sources of energy in a very rapid pace. Basically, there are two main methods of generating electrical energy. In one method, fuel is used as a source of electrical energy and whereas in another method, natural processes are used as the source of electrical energy. The fuel sources may include, but not limited to, natural gas, coal and nuclear fuel. Each of the two main methods comes up with some serious drawbacks. In the fuel based generation of electrical energy, the costs of the fuel as well as the by-products emitted out pollute the nature and thereby tending to have serious problems. In the natural processes for generation of electrical energy, the energy sources vary according to the technology used. For example, solar and wind energies produces unpredictable and inconsistent amount of electrical energy. Similarly, hydroelectric power provides a source of energy intermittently but damming of bodies of water causes a considerable harm to the environment. Additionally, water sources such as ocean waves, ocean thermal and buoyancy are very expensive to build and maintain in comparison to the amount of electrical energy they produce. These are very futile efforts in generating electrical energy.

### SUMMARY OF THE INVENTION

The present invention discloses a gravity based energy conversion device. In one aspect of the present invention, a gravity based energy conversion device includes a circular member, a first container and a second container suspended on either sides of the circular member for generating bi-directional circular motion at the circular member due to continuous ascending and descending movement of the first container and the second container under the influence of gravitational force, and a rotational energy conversion unit coupled to the circular member for converting the bi-directional circular motion at the circular member into an unidirectional rotational movement for generation of electrical energy.

In another aspect of the present invention, a gravity based energy conversion device includes a circular member, a first container and a second container suspended on either sides of the circular member for generating bi-directional circular motion at the circular member due to continuous ascending and descending movement of the first container and the second container under the influence of gravitational force, a rotational energy conversion unit coupled to the circular member for converting the bi-directional circular motion at the circular member into an unidirectional rotational movement for generation of primary electrical energy, and a first winged rotary member and a second winged rotary member for generating secondary electrical energy by virtue of rotation of the first rotary member and the second rotary member due to the ascending and descending movement of the first container and the second container.

### BRIEF DESCRIPTION OF THE ACCOMPANYING DRAWINGS

FIG. 1 illustrates a block diagram of a gravity based energy conversion system 100, according to the present invention.

FIG. 2 is a schematic representation illustrating a gravity based energy conversion system, according to one embodiment.

FIG. 3 is a schematic representation illustrating a gravity based energy conversion system, according to another embodiment.

FIG. 4 is a schematic representation illustrating a gravity based energy conversion system, according to yet another embodiment.

FIG. 5 is a schematic representation illustrating a gravity based energy conversion system, according to further another embodiment.

The drawings described herein are for illustration purposes only and are not intended to limit the scope of the present disclosure in any way.

### DETAILED DESCRIPTION OF THE INVENTION

The present invention provides a gravity based energy conversion system. The following description is merely exemplary in nature and is not intended to limit the present disclosure, applications, or uses. It should be understood that throughout the drawings, corresponding reference numerals indicate like or corresponding parts and features.

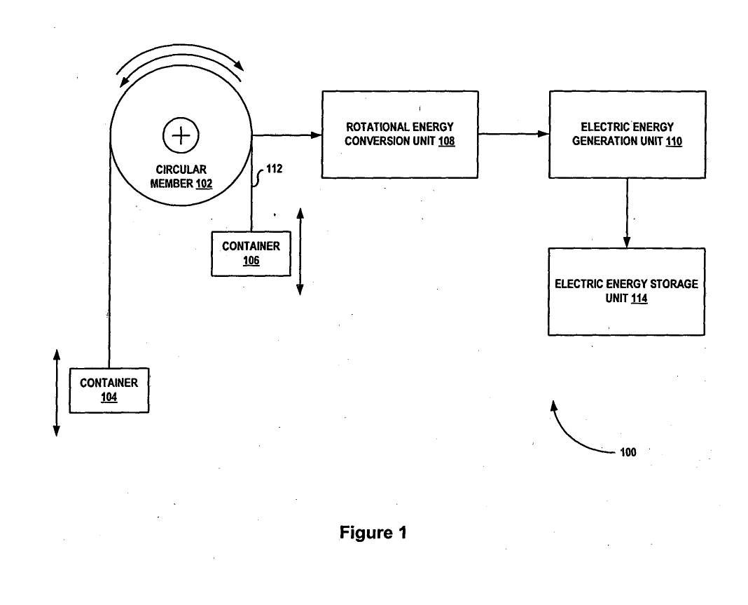

FIG. 1 illustrates a block diagram of a gravity based energy conversion system 100, according to the present invention. The gravity based energy conversion system 100 includes a circular pulley 102, a first container 104, a second container 106, a rotational energy conversion unit 108, and an electric energy generation unit 110. The first container 104 and the second container 106 are suspended on either sides of the circular member 102 using a connecting member 112. The circular member 102 may be a sprocket, a sheave, a pulley and the like. The connection member 112 may be a wired rope, a chain, and so on. The first container 104 and the second container 106 are designed to contain mass (e.g., water, snow, etc.) for generating ascending and descending movements in the vertical direction.

According to the present invention, weight of the first container 104 and the second container 106 is altered to obtain continuous ascending and descending movements of the first container 104 and the second container 106. The ascending and descending movements of the first container 104 and the second container 106 generates bi-directional clockwise and anti-clockwise motion at the circular member 102. The rotational energy conversion unit 108 converts the bi-directional motion of the circular member 102 into an unidirectional rotational movement. The rotational energy conversion unit 108 feeds the rotational energy to the electrical energy generation unit 110 (e.g., a generator) which then generates electric energy. The gravity based energy generation system 100 may include an electric energy storage unit 114 for storing electric energy generated by the electric energy generation unit 110.

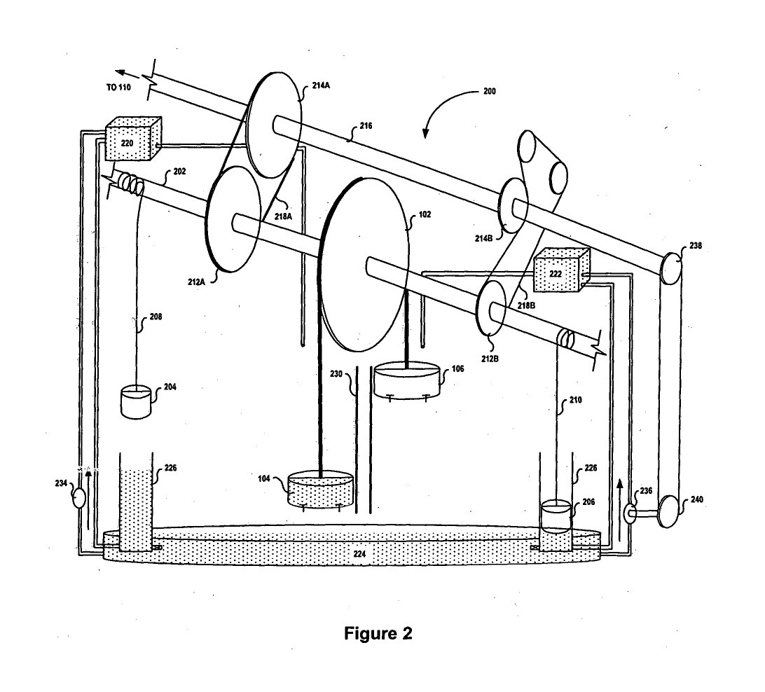

FIG. 2 is a schematic representation illustrating a gravity based energy conversion system 200, according to one embodiment. The gravity based energy conversion system 200 is an exemplary implementation of the gravity based energy conversion system 100 of FIG. 1. The gravity based energy conversion system 200 includes a circular member 102 around which the first container 104 and the second container 106 are suspended on either sides using a chain 112. The circular member 106 is mounted on a shaft 202. The gravity based energy conversion system 200 includes a first weight 204 and a second weight 206 suspended from the first end and the second end of the shaft 202 using ropes 208 and 210 respectively. The shaft 202 also carries circular members 212A and 212B which is connected to circular members 214A and 214B mounted on a parallel shaft 216 using chain 218A and 218B, respectively. The end of the shaft 216 is coupled to an electrical energy generator 110. The circular members 212A and 212B mounted on the shaft 202 and the circular members 214A and 214B mounted on the shaft 216 forms the rotational energy conversion unit 108.

The gravity based energy conversion system 200 also includes a reservoir 220 and a reservoir 222 for adding mass to the first container 104 and the second container 106 respectively. Additionally, the gravity based energy conversion system 200 includes a storage unit 224 for storing the mass discharged from the first container 104 and the second container 106 when the first container 104 and the second container 106 are at bottom most position. The gravity based energy conversion system 200 includes guide ways 230 and 232 to guide the descending first and second containers 104 and 106 respectively.

In an exemplary operation, when the first container 104 is at a top most position, the second container 106 is at a bottom most position. When the first container 104 is the top most position, the reservoir 220 fills water into the first container 104. On the other hand, when the second container 106 is at the bottom most position, the second container 106 discharges the water into the storage unit 224. Due to the difference in weight of the first container 104 and the second container 106, the first container 104 descends in the downward direction under the influence of gravitational force while the second container 106 ascends in the upward direction. As a result, the circular member 102 experiences an anticlockwise motion due to descending movement of the first container 104 and the ascending movement of the second container 106. When the first container 104 reaches a bottom most position above the storage unit 224, the water in the first container 104 is discharged into the storage unit 224. In one embodiment, the first container 104 may contain an opening at the bottom that is mechanically operated when the first container 104 reaches the bottom most position for discharging water contained in the first container 104. In another embodiment, the first container 104 may contain an opening at the bottom that is operated using electro-mechanical means (sensors and valves) for discharging water contained in the first container 104.

When the first container 104 is at the bottom most position, the second container 106 is at the top most position. When the second container 106 reaches the top most position, the reservoir 222 fills water in the second container 106. Due to difference in the weights, the second container 106 descends in the downward direction under the influence of gravity and the first container 104 ascends in the upward direction. Consequently, the circular member 102 experiences a circular motion in a clockwise direction. The anti-clockwise and clockwise circular motion of the circular member 102 is converted into unidirectional rotational movement at the shaft 216 via the circular members 212A and 212B, and the circular members 214A and 214B. The rotational movement of the shaft 216 is fed to the electrical energy generation unit 110 for generation of electrical energy.

The ascending and the descending movements of the first container 104 and the second container 106 are controlled by the pair of weights 204 and 206. For example, when the second container 106 is empty and is at the bottom most position and the first container 104 is filled with water and is at the top most position, the first container 104 starts descending in the downward direction. Consequently, the rope 208 suspending the first weight 204 is wound onto the shaft 202 due to counter clockwise circular motion experienced at the circular member 102 and the rope 210 suspending the second weight 206 is unwound from the shaft 202. This leads to lifting of the first weight 204 from the first vertical column 228 which in turn sucks water from the storage unit 224. Thus, the weight of the first weight 204 acts like a braking mechanism and reduces the speed of the first container 104. The loss of energy in the movement of the first container 104 is compensated by the increase in potential energy of the first weight 204. The suction pressure that has to be generated in the first vertical column 228 by the raising the first weight 204 also counters the speed of descent of the first container 104 before the first container 104 comes to halt at the bottom most position. The gradual reduction in speed of the descending first container 104 assists in bringing the first container 104 to a non-abrupt and non-chain snapping halt. Further, as the second container 106 descends towards the bottom most position, the first weight 204 moves down into the first vertical column 228, resulting in exertion of pressure on the water in the first vertical column 228 which in turn plunges water into the reservoir 222.

Now consider that the first container 104 is empty and is at the bottom most position and the second container 106 is full and is at the top most position. This causes the second container 106 to start descending in the downward direction. Consequently, the rope 208 suspending the first weight 204 is unwound from the shaft 202 due to clockwise circular motion experienced at the circular member 102 and the rope 210 suspending the second weight 206 is wound onto the shaft 202. This leads to lifting of the second weight 206 from the second vertical column 226 which in turn sucks water from the storage unit 224. Thus, the weight of the second weight 206 acts like a braking mechanism and reduces the speed of the second container 106. The loss of energy in the movement of the second container 106 is compensated by the increase in potential energy of the second weight 206. The suction pressure that has to be generated in the second vertical column 226 by the raising the second weight 206 also counters the speed of descent of the second container 106 before the second container 106 comes to halt at the bottom most position. The gradual reduction in speed of the descending second container 106 assists in bringing the second container 106 to a non-abrupt and non-chain snapping halt. Further, as the first container 104 descends towards the bottom most position, the second weight 206 moves down into the second vertical column 226, resulting in exertion of pressure on the water in the second vertical column 226 which in turn plunges water into the reservoir 220.

It can be noted that the first weight 204 and the second weight 206 are of equal weight. It can also be noted that the first weight 204 and the second weight 206 are of lesser weight than the first container 104 and the second container 106. Further, the length of the ropes 208 and 210 suspending the first weight 208 and the second weight 206 determines when the first weight 204 and the second weight 206 is going to be lifted away from the ground from the first vertical column 228 and the second vertical column respectively.

The gravity based energy conversion system 200 also includes a refilling unit for refilling the water into the reservoirs 220 and 222. The refilling unit includes mechanical pumps 234 and 236 for pumping water from the storage unit 224 to the reservoirs 220 and 222. In some embodiments, the mechanical pumps 234 and 236 are operated using the unidirectional circular motion of the shaft 216 due to the ascending and descending movements of the containers 104 and 106. In these embodiments, the pulleys 238 and 240 are used to translate the motion of the shaft 216 for operating the mechanical pumps 234 and 236. Alternatively, one skilled in the art may realise that wind based water pumps, or solar based water pumps may also be used for refilling water from the storage unit 224 to the reservoirs 220 and 222.

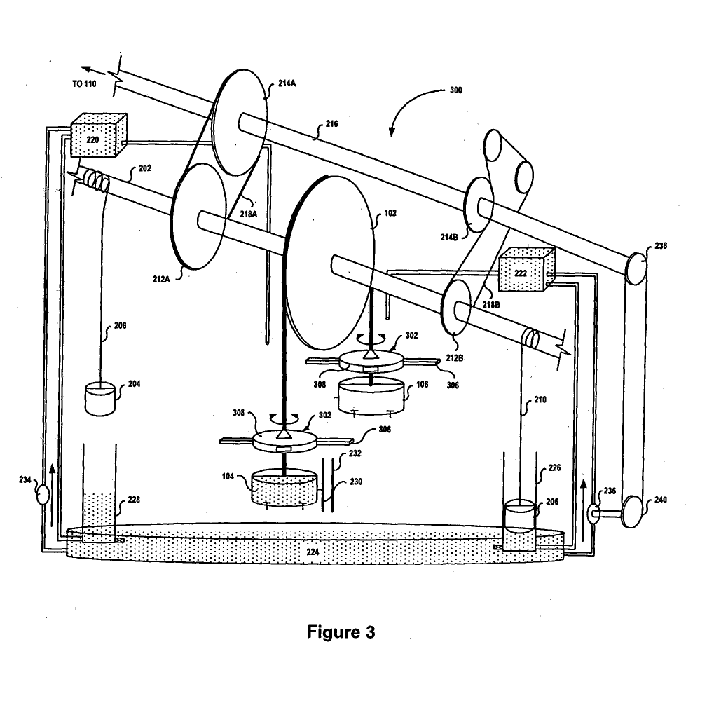

FIG. 3 is a schematic representation illustrating a gravity based energy conversion system 300, according to another embodiment. The gravity based energy conversion system 300 is an exemplary implementation of the gravity based energy conversion system 100 of FIG. 1. It can be seen that the gravity based energy conversion system 300 is similar to the gravity based energy conversion system 200 of FIG. 2 except the gravity based energy conversion system 100 includes a first winged rotary member 302 and a second winged rotary member 304 disposed along the axis of the first container 104 and the second container 106 respectively. The first and second winged rotary members 302 and 304 include wings 306 attached to hub 308. In an exemplary operation, when the first container 104 and the second container 106 ascends and descends in a vertical direction, the first winged rotary member 302 and the second winged rotary member 304 rotate due to the upward and downward thrust of air exerted by virtue the ascending and descending movements of the first container 104 and the second container 106. Consequently, the first winged rotary member 302 and the second winged rotary member 304 generates electrical energy by virtue of the rotation energy. In some embodiments, the hub 308 includes an alternator (not shown) for generating electrical energy.

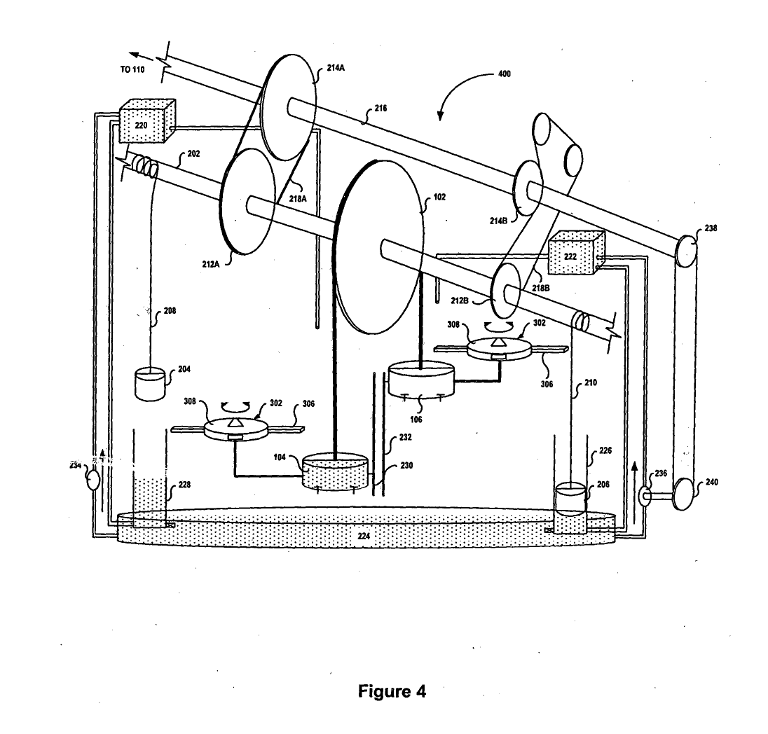

FIG. 4 is a schematic representation illustrating a gravity based energy conversion system 400, according to yet another embodiment. It can be seen that the gravity based energy conversion system 400 is similar to the gravity based energy conversion system 300 of FIG. 3 except that the first winged rotary member 302 and the second winged rotary member 304 are disposed away from the axis of the first container 104 and the second container 106 respectively.

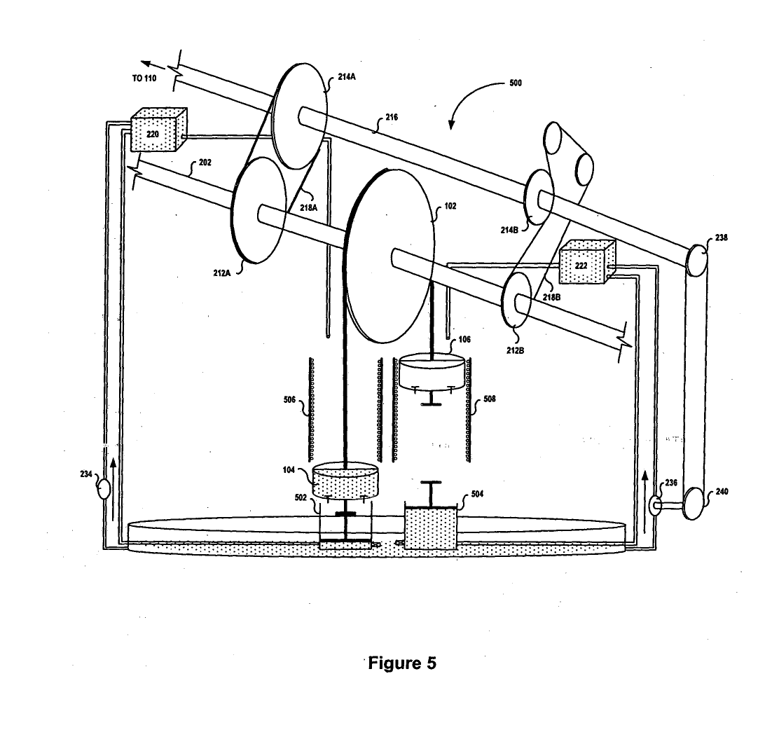

FIG. 5 is a schematic representation illustrating a gravity based energy conversion system 500, according to further another embodiment. It can be seen that the gravity based energy conversion system 500 is similar to the gravity based energy conversion system 200 of FIG. 2 except that the gravity based energy system 500 includes a vertical plungers 502 and 504 filled with water for constantly replenishing water in the reservoirs 220 and 222. For example, when the first container 104 reaches the bottom most position, the vertical plunger 502 filled with water moves down and water is pumped into the reservoir 220. Similarly, when the second container 106 reaches the bottom most position, the vertical plunger 504 filled with water moves down and water is pumped into the reservoir 222. Also, the gravity based energy conversion system 500 includes braking units 506 and 508 for controlling movement of the first container 104 and the second container 106.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

We claim:

1. A device comprising:
a circular member;
a first container and a second container suspended on either sides of the circular member for generating bi-directional circular motion at the circular member due to continuous ascending and descending movement of the first container and the second container under the influence of gravitational force; and
a rotational energy conversion unit coupled to the circular member for converting the bi-directional circular motion at the circular member into an unidirectional rotational movement for generation of electrical energy.

2. The device of claim 1, further comprising:
an electrical energy generation unit coupled to the rotational energy conversion unit for generating electrical energy from the unidirectional rotational movement fed by the rotational energy conversion unit.

3. The device of claim 1, wherein the first container and the second container contains unequal mass.

4. The device of claim 1, further comprising:
a pair of weights disposed at either end of a shaft carrying the circular member for controlling ascending and descending movements of the first container and the second container.

5. The device of claim 4, further comprising:
a first reservoir for adding mass to the first container when the first container is at the top most position.

6. The device of claim 5, further comprising:
a second reservoir for adding mass to the second container when the second container is at the top most position.

7. The device of claim 6, further comprising:
a storage unit for storing the mass discharged from the first container and the second container when the first container and the second container at the bottom most position respectively.

8. The device of claim 7, further comprising:
a refilling unit for refilling the first reservoir and the second reservoir with the mass stored in the storage unit.

9. The device of claim 8, further comprising:
a pair of vertical columns for refilling the first reservoir and the second reservoir due to ascending and descending movements of the pair of weights.

10. A device comprising:
a circular member;
a first container and a second container suspended on either sides of the circular member for generating bi-directional circular motion at the circular member due to continuous ascending and descending movement of the first container and the second container under the influence of gravitational force;
a rotational energy conversion unit coupled to the circular member for converting the bi-directional circular motion at the circular member into an unidirectional rotational movement for generation of primary electrical energy; and
a first winged rotary member and a second winged rotary member for generating secondary electrical energy by virtue of rotation of the first rotary member and the second rotary member due to the ascending and descending movement of the first container and the second container.

11. The device of claim 10, further comprising:
an electrical energy generation unit coupled to the rotational energy conversion unit for generating primary electrical energy from the unidirectional rotational movement fed by the rotational energy conversion unit.

12. The device of claim 10, wherein the first container and the second container contains unequal mass.

13. The device of claim 10, further comprising:
a pair of weights disposed at either end of a shaft carrying the circular member for controlling ascending and descending movements of the first container and the second container.

14. The device of claim 13, further comprising:
a first reservoir for adding mass to the first container when the first container is at the top most position.

15. The device of claim 14, further comprising:
a second reservoir for adding mass to the second container when the second container is at the top most position.

16. The device of claim 15, further comprising:
a storage unit for storing the mass discharged from the first container and the second container when the first container and the second container at the bottom most position respectively.

17. The device of claim 16, further comprising:
a refilling unit for refilling the first reservoir and the second reservoir with the mass stored in the storage unit.

18. The device of claim 17, further comprising:
a pair of vertical columns for refilling the first reservoir and the second reservoir due to ascending and descending movements of the pair of weights.
